(19) United States
(12) Patent Application Publication
(10) Pub. No.: US 2010/0221566 A1
(43) Pub. Date: Sep. 2, 2010

(54) PROCESS FOR PRODUCING METAL MEMBER, AND METAL MEMBER

(76) Inventors: Akiko Inoue, Aichi (JP); Takahiro Sekigawa, Aichi (JP); Kazuyuki Oguri, Aichi (JP)

Correspondence Address: WENDEROTH, LIND & PONACK, L.L.P., 1030 15th Street, N.W.,, Suite 400 East, Washington, DC, 20005-1503, US

(21) Appl. No.: 12/664,457

(22) PCT Filed: Jun. 3, 2009
(86) PCT No.: PCT/JP2009/060122

§ 371 Date: Dec. 14, 2009

(30) Foreign Application Priority Data
Jun. 5, 2008 (JP) 2008-148170

(51) Int. Cl. B32B 15/00; C21D 7/06

(52) U.S. Cl. 428/544; 72/53

(57) ABSTRACT

A process for producing a metal member having improved fatigue life via a simple process. The process for producing a metal member comprises a burr removal step of removing burrs from the corners and edges of a metal member, and a projection step, which is performed after the burr removal step, without performing a chamfering treatment, of projecting particles having an average particle size of not less than 10 μm and not more than 400 μm onto a surface of the metal member.

### TECHNICAL FIELD

The present invention relates to a process for producing a metal member having improved fatigue life by performing a shot peening treatment, and also relates to a metal member.

### BACKGROUND ART

Metal members used in the structural members for aircraft and automobiles and the like are typically subjected to surface modification via a shot peening treatment in order to extend their fatigue life. Shot peening is a process in which particles having a particle size of 500 μm to 800 μm are projected onto the surface of a metal material, either together with a stream of compressed air or by accelerating the particles via the rotation of an impeller, thereby increasing the hardness of the metal material surface and forming a layer having compressive residual stress at a certain depth.

Non-Patent Citation 1 discloses a fine particle shot peening treatment that uses finer particles (for example, with an average particle size of not more than 400 μm) as a method of further enhancing the improvement in the fatigue life of the metal member.

Non Patent Citation 1: Yasuhiro KATAOKA et al: “Surface Modification of Aluminum Alloys by Micro Particles Peening and Coating”, Research Report from Aichi Industrial Technology Institute (2002).

### DISCLOSURE OF INVENTION

As illustrated in FIG. 1, when a shot peening treatment is performed on a surface (the treatment surface) 11 of a metal member 10 from which burrs have been removed from the corners and edges following machining, burrs and overhangs 12 tend to be generated at the corners and edges of the metal member. When these types of burrs and overhangs occur at the corners and edges, the corners and edges act as origins that lead to a deterioration in the fatigue life of the metal member. Particularly in the case of shot peening treatments that use larger particles, because the amount of deformation of the metal member is large, fatigue life deterioration caused by overhangs at the corners and edges becomes increasingly problematic.

Accordingly, as disclosed in AMS (Aerospace Material Specification) 2430, arc-shaped chamfering (round chamfering) of the corners and edges of a metal material is required as pretreatment for shot peening. By performing round chamfering of the corners and edges, any deterioration in the fatigue life caused by the generation of overhangs or burrs at the corners and edges as a result of the shot peening can be prevented. Even in fine particle shot peening, the corners and edges of the metal member are typically subjected to round chamfering as a pretreatment.

In the production of actual equipment, round chamfering that exceeds the level of chamfering applied during typical machining processes is used to ensure reliable prevention of any deterioration in fatigue strength. However, a problem arises in that in order to achieve such large chamfering, an additional time is required for the pretreatment.

The present invention has been developed in light of these circumstances, and has an object of providing a process for producing a metal member having improved fatigue life that is simpler than conventional processes.

In order to achieve the above object, the present invention provides a process for producing a metal member, the process comprising: a burr removal step of removing burrs from the corners and edges of a metal member, and a projection step, which is performed after the burr removal step, without performing a chamfering treatment, of projecting particles having an average particle size of not less than 10 μm and not more than 400 μm onto a surface of the metal member.

As a result of intensive investigations, the inventors of the present invention discovered that in a fine particle shot peening treatment in which particles having an average particle size of not less than 10 μm and not more than 400 μm are projected onto the surface of a metal member, the occurrence of overhangs and burrs at the corners and edges of the shot peened metal member could be prevented, even if the step of chamfering of the corners and edges that has typically been used as a pretreatment to shot peening was not performed. Using the production process of the present invention enables deterioration in the fatigue life to be prevented even with the exclusion of the chamfering of the corners and edges, and therefore the time required for producing the metal member can be shortened dramatically, and a metal member can be produced that retains the improvement in fatigue life provided by the shot peening treatment. By removing burrs from the corners and edges of the metal member prior to the fine particle shot peening treatment, any deterioration in the fatigue life can be completely prevented.

Furthermore, the present invention also provides a metal member, the surface of which has been treated by removing burrs from the corners and edges of the metal member, and then, without performing a chamfering treatment on the corners and edges, projecting particles having an average particle size of not less than 10 μm and not more than 400 μm onto the surface.

In this manner, a metal member with a surface that has been subjected to a fine particle shot peening treatment by projecting particles having an average particle size of not less than 10 μm and not more than 400 μm onto the surface, without performing a preliminary chamfering treatment of the corners and edges of the metal member, becomes a metal member for which deterioration in the fatigue life has been effectively prevented. Further, because the corners and edges are not chamfered, the shape of the member is retained, enabling the production of a high-quality metal member.

The present invention enables the pretreatment step of chamfering the corners and edges to be omitted, meaning the time required for production of the metal member can be shortened dramatically, while still enabling the production of a metal member for which deterioration in the fatigue life has been prevented. The present invention also yields a metal member of favorable quality.

### BRIEF DESCRIPTION OF DRAWINGS

FIG. 1 A schematic illustration representing overhang at the corner and edge of a metal member as a result of a shot peening treatment.

FIG. 2 A graph displaying the fatigue life of test pieces of an example and comparative examples.

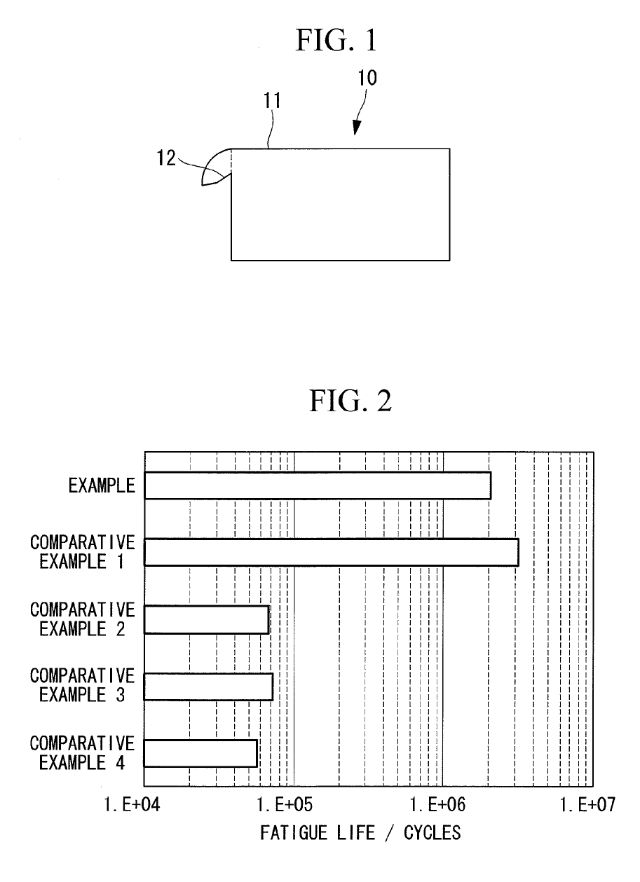

### EXPLANATION OF REFERENCE

10: Metal member
11: Treatment surface
12: Overhang

### BEST MODE FOR CARRYING OUT THE INVENTION

A description of an embodiment of the process for producing a metal member according to the present invention is presented below.

The metal member of this embodiment is formed from a lightweight metal such as an aluminum alloy, a titanium alloy or a magnesium alloy.

The surface of the metal member is subjected to a fine particle shot peening treatment without first performing the step of arc-shaped round chamfering of the corners and edges of the metal member that is typically conducted as a pretreatment prior to the fine particle shot peening. However, prior to the fine particle shot peening treatment, it is preferable that the corners and edges of the metal member are subjected to light chamfering to remove burrs.

Although the material that constitutes the projected particles (shot media) used in the fine particle shot peening treatment of the present embodiment causes no dramatic difference in the degree of improvement in the fatigue life, ceramic particles such as silica particles, alumina particles and zirconia particles are preferred. The average particle size of the shot media is typically not less than 10 μm and not more than 400 μm, is preferably not less than 20 μm and not more than 250 μm, and is more preferably not less than 30 μm and not more than 150 μm. If the average particle size of the shot media exceeds 400 μm, then the amount of deformation of the metal member caused by the shot peening treatment is large, which increases the likelihood of overhangs at the corners and edges of the metal member, leading to a deterioration in the fatigue life. If the average particle size is less than 10 μm, then achieving a stable blast state becomes difficult.

The arc height value (intensity), which is an indicator of the intensity of the shot peening, is typically not less than 0.05 mmN and not more than 0.3 mmN, is preferably not less than 0.075 mmN and not more than 0.2 mmN, and is more preferably not less than 0.08 mmN and not more than 0.095 mmN. The blast pressure of the compressed air during particle projection is set so as to achieve an arc height value within the above range.

The coverage of the shot peening treatment is preferably not less than 100% and not more than 1,000%. If the coverage level is less than 100%, then regions that have not been shot remain, meaning a satisfactory improvement in the fatigue life cannot be obtained. Furthermore, if the coverage level exceeds 1,000%, then the roughness of the material surface increases, meaning a satisfactory improvement in the fatigue life cannot be obtained.

In a metal member that has been subjected to fine particle shot peening under the conditions described above, a high compressive residual stress exists either at the outermost surface of the member, or within the vicinity thereof. As a result, the surface is strengthened, and the fatigue life increases. Furthermore, in the fine particle shot peening treatment performed under the above conditions, even if the step of chamfering treatment of the corners and edges that has conventionally been required is not performed, overhangs do not occur at the corners and edges of the metal member. Accordingly, fatigue deterioration in which the corners and edges act as origins becomes unlikely. Moreover, because the shapes of the corners and edges are retained, a high-quality metal member is obtained.

It is preferable that burrs on the corners and edges of the metal member are removed prior to the fine particle shot peening treatment, as this enables fatigue deterioration in which the corners and edges act as origins for the deterioration to be more reliably prevented, and enables the quality of the metal member to be further improved.

In the process for producing a metal member according to the present embodiment, because the step of chamfering the corners and edges of the member is omitted, the required production time can be shortened dramatically.

### EXAMPLES

### Example

A test piece comprising a sheet of an aluminum alloy material (7050-T7451, dimensions: 190 mm×45 mm×5 mm) was subjected to light chamfering (corner finishing of 0.075 mm (0.003 inches)) to remove burrs from the corners and edges of the test piece.

Using ceramic particles (alumina/silica ceramic particles, average particle size: 45 μm) as the shot media, the surface of the test piece was subjected to a shot peening treatment under conditions including a blast pressure of 0.4 MPa and a treatment time of 30 seconds. The arc height under the above conditions was 0.08 mmN, and the coverage was at least 100%.

Inspection of the test piece of the example following the shot peening treatment using a scanning electron microscope revealed no visible overhangs or burrs at the corners or edges of the test piece. Further, the corners and edges retained the shapes produced following the light chamfering described above.

### Comparative Example 1

The corners and edges of an identical test piece to the above example were subjected to arc-shaped round chamfering of 0.75 mm (0.03 inches). Subsequently, the surface of the test piece was subjected to a shot peening treatment under the same conditions as those described for the example.

Inspection of the test piece of comparative example 1 following the shot peening treatment using a scanning electron microscope revealed no visible overhangs or burrs at the corners or edges of the test piece. Further, the corners and edges retained the round chamfered shape described above.

### Comparative Example 2

The corners and edges of an identical test piece to the above example were subjected to light chamfering (corner finishing of 0.075 mm (0.003 inches)) to remove burrs. Subsequently, using metal particles (cut wire shot AWCR28, average particle size: 0.8 mm) as the shot media, the surface of the test piece was subjected to a shot peening treatment using a blast pressure of 0.1 MPa. The arc height under the above conditions was 0.180 mmA, and the coverage was at least 100%.

Inspection of the test piece of comparative example 2 following the shot peening treatment using a scanning electron microscope confirmed that overhangs and burrs had been generated at the corners and edges of the test piece.

### Comparative Example 3

The corners and edges of an identical test piece to the above example were subjected to arc-shaped round chamfering of 0.75 mm (0.03 inches). Subsequently, the surface of the test piece was subjected to a shot peening treatment under the same conditions as those described for comparative example 2.

Inspection of the test piece of comparative example 3 following the shot peening treatment using a scanning electron microscope revealed no visible overhangs or burrs at the corners or edges of the test piece. However, the corners and edges of the test piece had not retained the shapes produced immediately following the round chamfering treatment, with the corners and edges having larger arcs than the arcs produced by the round chamfering treatment.

### Comparative Example 4

The corners and edges of an identical test piece to the above example were subjected to light chamfering (corner finishing of 0.075 mm (0.003 inches)) to remove burrs. The test piece of comparative example 4 was not subjected to shot peening.

The test pieces of the example and comparative examples 1 to 4 were each subjected to a uniaxial fatigue test. The test conditions included a stress ratio of 0.1, a maximum stress of 344.7 MPa, and a frequency of 13 Hz.

FIG. 2 illustrates the fatigue life of each test piece. The test pieces of the example and the comparative example 1, which had been subjected to a fine particle shot peening treatment, exhibited dramatic improvements in the fatigue life compared with both the comparative examples 2 and 3 which had been subjected to a large particle shot peening treatment, and the comparative example 4 that underwent no shot peening. The example produced a fatigue life that was substantially the same as that of the comparative example 1 that had undergone a chamfering treatment. In other words, in the case of fine particle shot peening, excellent fatigue life was able to be achieved even without performing significant round chamfering of the corners and edges of the metal member.

1. A process for producing a metal member, the process comprising:
a burr removal step of removing burrs from corners and edges of a metal member, and
a projection step, which is performed after the burr removal step, without performing a chamfering treatment, of projecting particles having an average particle size of not less than 10 μm and not more than 400 μm onto a surface of the metal member.

2. A metal member, a surface of which has been treated by removing burrs from corners and edges of the metal member, and then, without performing a chamfering treatment on the corners and edges, projecting particles having an average particle size of not less than 10 μm and not more than 400 μm onto the surface.
